(19) United States
(12) Patent Application Publication
(10) Pub. No.: US 2004/0199674 A1
(43) Pub. Date: Oct. 7, 2004

(54) Interface circuit for process connections

(76) Inventor: Hartmut B. Brinkhus, Heidelberg (DE)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/785,645

(22) Filed: Feb. 24, 2004

(30) Foreign Application Priority Data
Feb. 24, 2003 (DE) 103 08 027.9

(51) Int. Cl. G06F 3/00

(52) U.S. Cl. 710/1

(57) ABSTRACT

A universal, programmable interface circuit which contains a plurality of controllable switches, a plurality of controllable multiplexers, at least one analog/digital converter, and at least one digital/analog converter. These components are activated, deactivated, or changed in their operating or switching states by means of control signals, wherein different functions can be assigned to each bidirectional input connection. Thus, each input connection can have a plurality of digital or analog functions for bidirectional exchange of data, measurement values, control signals, or the like between a computer and instruments of a technical process.

### FIELD OF THE INVENTION

The invention relates to an interface circuit for process connections.

### BACKGROUND OF THE INVENTION

In industrial applications, data, measurement values, control signals, and the like must be transferred to a computer or from the computer back to machines and instruments. In more complex applications, a large number of interface circuits, which can go up to several thousand, are required. The connection for interface circuits communicating with the industrial environment is designated in general and also in the following as an I/O pin.

Fundamentally, the function of an I/O pin is determined by:

a) its physical properties,

b) upstream or downstream higher system functions, and

c) auxiliary functions.

The physical properties are usually determined by an integrated circuit, which makes the I/O pin available, and if necessary by its external circuitry.

For example, an analog input is defined by its properties as an input for voltages or current, thus analog signals. Additional properties are added, such as input impedance, input range, transient response, overvoltage resistance, etc.

Its system function is determined by analog/digital converters, if necessary, analog or digital filters, sequence controllers, processors, etc. Various forms of realization can be selected for these functions and their distribution among existing system components.

Auxiliary functions include the power supply, the connection of the I/O pin to the process, the connection of the higher order systems, e.g., via a field bus, and the mechanical properties.

Until now, typical solutions used exchangeable components for realizing different types of I/O pins. These components determined the physical properties of the I/O pins. Together with the auxiliary functions, they are integrated into the so-called front-end. For the most part, higher system functions are not present here.

Until now, different components, which realize the required properties and especially the physical properties, have been produced for each specific type of I/O pin. This means that an enormous array of different interface circuits must be produced, assembled, and kept in storage in case of failures. Typically, the interface circuits are formed as pluggable modules, which have identical arrangements of connection legs, so that confusion may easily occur during assembly, which can represent a source of error.

One example includes SPS systems, such as S7 by Siemens. The front-end is designated as a “decentralized peripheral” and consists here of two mechanically and electrically separated components, which are set one on top of the other. Here, the auxiliary functions are located in a universal-use base component. The type and number of I/O pins is set by a second component, which can be set on the base component and which is available in many different types. The current states of the I/O pins are transferred over a base component and then via a field-bus connection to a central computer system. There, higher system functions can then also be realized in software.

Another example includes terminal screws by the Wago company. Here, small units are set relative to each other as on a string of pearls. Each element contains only one or a few I/O pins with the terminal screws to the process. Power supply and connection to a higher-order field-bus system are arranged in separate elements. Here, system functions are then also realized.

### SUMMARY OF THE INVENTION

The problem of the invention is to improve the known interface circuits for process connections such that a universal interface circuit is created, whose properties can be programmed for all common requirements.

This problem is solved by the features given in claim 1. Advantageous configurations and refinements of the invention can be taken from the subordinate claims.

Briefly, therefore, the invention is directed to an interface circuit for process connections to computers. The interface circuit comprises at least one bidirectional input connection; at least one bidirectional output connection, which is connected to a logic circuit; a plurality of switches, which can be controlled by signals, whose inputs are connected directly or indirectly to at least one input connection; several multiplexers which can be controlled by signals; at least one analog comparator; and at least one digital/analog converter. According to the state of one or more of the signals which control the switches and multiplexers the components are activated, deactivated, or changeable into different operating or switching states, with different analog or digital functions being assignable to the one or more bidirectional input connections.

Other objects and features will be in part apparent and in part pointed out hereinafter.

### BRIEF DESCRIPTION OF THE FIGURES

FIG. 1, a block circuit diagram of an interface circuit with decoupling;

FIG. 2, a more detailed block circuit diagram of an interface circuit chip;

FIG. 3, a more detailed block circuit diagram of the control logic for the interface circuit chip of FIG. 2;

FIG. 4, a block circuit diagram for explaining the cascade arrangement; and

FIG. 5, a block circuit diagram similar to FIG. 1, but without decoupling.

Corresponding reference characters indicate corresponding parts throughout the drawings.

### DETAILED DESCRIPTION OF PREFERRED EMBODIMENTS

This application claims priority of German application 103 08 027.9, filed Feb. 24, 2003, the entire disclosure of which is explicitly incorporated by reference.

The basic principle of the invention lies in a universal, programmable interface circuit, which has a plurality of program-controllable switches and also a plurality of components required to realize physical properties, with different functions being selected according to the switching states of the switches. In general, the physical properties of each I/O pin are programmable, with each I/O pin being able to assume a wide range of functions as digital or analog inputs or outputs.

The control of the interface circuit is performed over a logic circuit, e.g., an FPGA (field programmable gate array) or an ASIC [application-specific integrated circuit], and these circuits are connected to each other, preferably decoupled, e.g., via an optocoupler.

Only the absolutely required function elements are located in the interface circuit chip directly at the I/O pin on the decoupled side, all other functions, especially also system functions or “higher functions,” are realized on the other side of the decoupling device (in the following called FPGA side, because the control is currently performed by an FPGA=field programmable gate array). In this way, practically all required process functions can be realized with the same hardware electronics. The dividing line between simple and higher system functions is rather fluid. However, simple system functions usually require no logic operations and can be, e.g., an interrupt initiation or the counting of events, such as positive edges, for an I/O pin connected as a digital input. In contrast, higher system functions require more complex logic functions and can be, e.g., the measurement of the pulse width or period, the counting of pulses of a reference frequency between one positive edge and the next, negative edge at the I/O pin or between two consecutive positive edges. The measurement of rpm values also belongs to higher functions. To increase measurement accuracy, the measurement method can also be dynamically switched during operation between the counting of pulses per unit time (suitable for high rpm values) and the pulse width or period measurement (suitable for low rpm values). The detection of rpm=0 is derived precisely from the lack of another edge at the I/O pin and can be identified by exceeding a programmable time limit. These higher system functions, which in many cases are also realized in software, are always localized on the FPGA side in order to give the interface circuit chip a simple and universal structure.

A few functions result first through the meaningful interaction between the interface circuit and FPGA sides. The control of the interface circuit chip happens, for instance, synchronized in series over one data line per direction. Thus, there is a rigid time coupling between the interface circuit chip and the control circuit. This is used for a series of functions and brings a few advantages, which are referred to in the following description.

Another advantage of the new interface circuit is that the same hardware can be used for all types of I/O pins and all functions. This considerably simplifies the structure of control systems and switching cabinets, likewise the storage of replacement parts and maintenance expense. In the simplest case, additional interface circuits are provided in the system, which are activated only when needed, thus, e.g., if there is a defect in other pins. Simple reprogramming is sufficient. Therefore, redundant systems can likewise be realized very simply.

The power supply of the interface circuit chip is realized, e.g., via a DC/DC converter with a power converter, such as a transformer. The secondary side of the transformer is directly connected to the interface circuit chip. The generation of all required power-supply voltages, including rectification and filtering, can be integrated in the interface circuit chip.

The two decoupled data lines required for the decoupling of the interface circuit chip mentioned above (through optocouplers or magnetocouplers) could likewise be eliminated if this is taken care of, e.g., by the power converter used in the DC/DC conversion.

Physical Properties of the I/O Pins

The following physical properties of the I/O pins can be programmed:

input or output

digital or analog

voltage or current

variable resistance values (bus connection, fail safe).

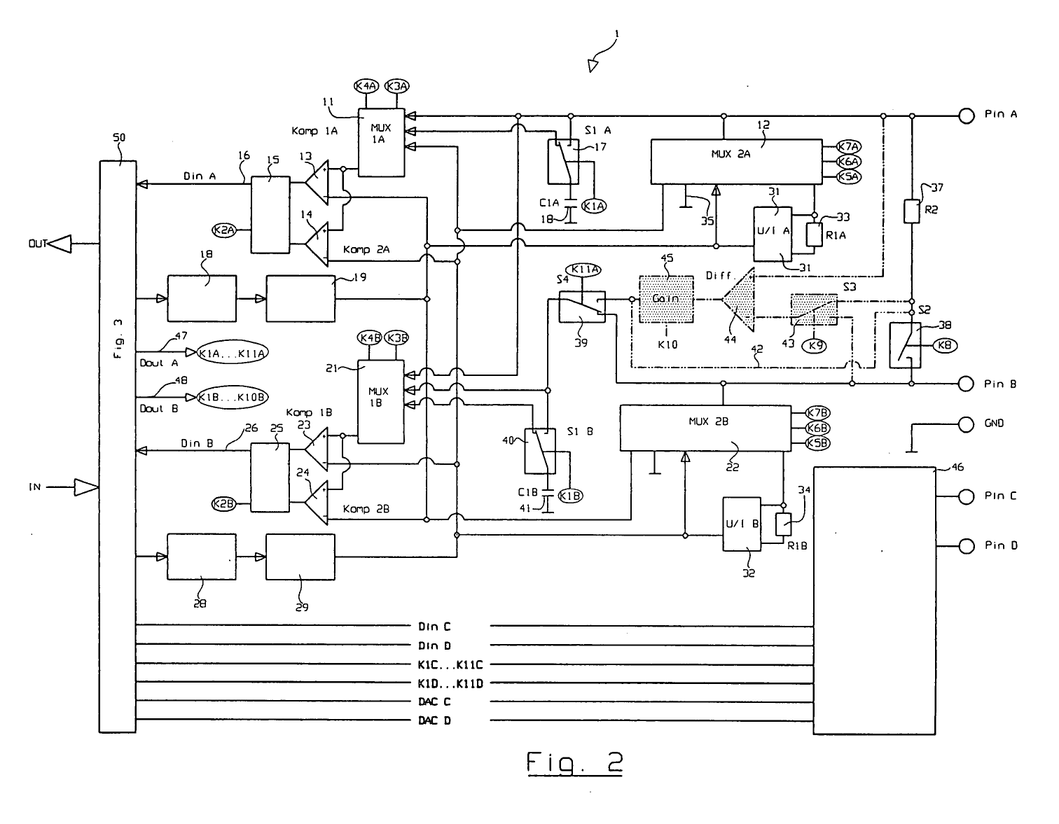

Consequently, with the use of one or two I/O pins for the respective function, the following basic functions are possible, e.g. (see FIG. 2):

digital input with programmable switching threshold and hysteresis response, e.g., for logic level, RS-232, etc.

digital difference input, e.g., for RS-422 or RS-485

digital output type PP (push-pull): low level<0.4 volt, high level programmable

digital output type LH: programmable low and high levels, programmable slew rate, e.g., also for RS-232

digital output type OD (=open drain)

digital difference output, e.g., for RS-485

analog ground-referenced voltage input, programmable input range (optional)

analog difference input for voltage

analog difference input for 0-20 mA or 4-20 mA

analog voltage output, e.g., +/−10 V

analog constant current output for 0-20 mA or 4-20 mA

For the embodiment of the interface circuit chip described in detail further below, two I/O pins receive the same properties in many of the basic functions mentioned above. For configuration as digital inputs, e.g., two I/O pins use the same settings of the two associated DACs (DAC=digital/analog converter), because only one DAC is provided for each I/O pin. One DAC sets the upper switching threshold (low>>high), and the other sets the hysteresis response or a lower switching threshold. For digital outputs, the DAC belonging to the corresponding I/O pin is used for setting the high level, and the other for the low level, if necessary. For a digital output with open collector or open drain, the DAC belonging to the corresponding I/O pin is not used. The use for setting a threshold to detect excess current at output level=low would be conceivable.

Two I/O pins can also be connected as a difference input, e.g., as:

analog difference input for voltages digital difference input, e.g., for RS-422 or RS-485 analog current input (0-20 mA).

System Functions:

For the system functions connected to the output of the I/O pins, exclusively digital functions are required, which can be realized usefully on the DC-coupled side, e.g., in an ASIC (=application-specific integrated circuit) or FPGA (=field programmable gate array). FPGAs are also available for which in the current system only parts of the FPGA can be reprogrammed while the remaining parts remain completely functional. Therefore, the system costs can be drastically reduced, because only a certain number of gates must also be provided in the FPGA for each I/O pin. The function of I/O pins can be determined only at the time of configuration of the entire system after on-site assembly.

For digital inputs, e.g., the following system functions are possible:

interrupt initiation

emergency shutdown

asynchronous or synchronous serial interface

modem control lines

synchronous serial interface (=SSI) for the connection of rotary sensors

counter

frequency measurement

pulse-width measurement

period measurement

incremental sensor interface, various modes.

Each input is basically an analog input, even when the result of the comparator delivered by the interface circuit chip is digital. Through the type of further processing in the FPGA, an analog/digital converter can be realized very simply for each I/O pin (see below). The result of the A/D conversion then enables further system functions, e.g.:

1) interrupt for exceeding and/or falling below threshold values

2) simultaneous sampling of several analog inputs

3) sensor signal processing (Pt100, thermoelement, DMS, etc.). For the bridge power supply, another interface circuit pin, e.g., which is configured as a constant current output, can be used (2-, 3-, or 4-wire configuration possible).

For digital outputs, e.g., the following system functions are possible:

1) frequency output

2) pulse-width modulated output (PWM), e.g., for DC motors

3) stepper-motor control

4) asynchronous or synchronous serial interface

5) modem control lines

6) synchronous serial interface (=SSI) for emulation of rotary sensors.

For an analog output, e.g., the following system functions are possible:

Output of complete analog signal shapes (e.g., sinusoid, free function, etc.)

Realization:

It was assumed that in most systems (SPS or switching cabinets for test benches, quality control, or the like), many I/O pins are required, sometimes several hundred or several thousand. For the most part, decoupling is also desirable or necessary. Often, a few I/O pins have the same properties and also must not be decoupled from each other.

A transformer for the DC/DC converter (for supplying the interface circuit chip) and two digital communications channels (one for each direction) are provided for each interface circuit chip. To keep the costs low, the number of I/O pins per interface circuit chip is set to four. This has no effect on the basic function of the interface circuit chip. In addition, the possibility of a cascade arrangement of interface circuit chips was also provided.

Advantages and disadvantages of the number of I/O pins per interface circuit chip

| | Advantages and | |
|---|---|---|
| I/O pins/chip | disadvantages | Costs/pin |
| 1 + GND | Decoupling for each pin | high |
| 2 + GND | Difference input, high | medium |
| | granularity | |
| 3 + GND | Difference input, high | medium |
| | granularity | |
| 4 + GND + cascade | Best compromise | low |
| arrangement | | |
| 8 + GND | Granularity less good | low |

In further discussion, only the type with four I/O pins+GND is referenced for reasons of simplicity.

Note: in systems with several interface circuit chips, their control is usually performed with a single FPGA. The system functions are also realized in this FPGA or in software. All interface circuit chips are usually controlled in sync so that the sampling of inputs and the setting of outputs can also be performed simultaneously. Therefore, the distribution of I/O pins of an interface, for which several I/O pins are necessary, has no significance for the function, e.g., for an incremental sensor interface on various interface circuit chips.

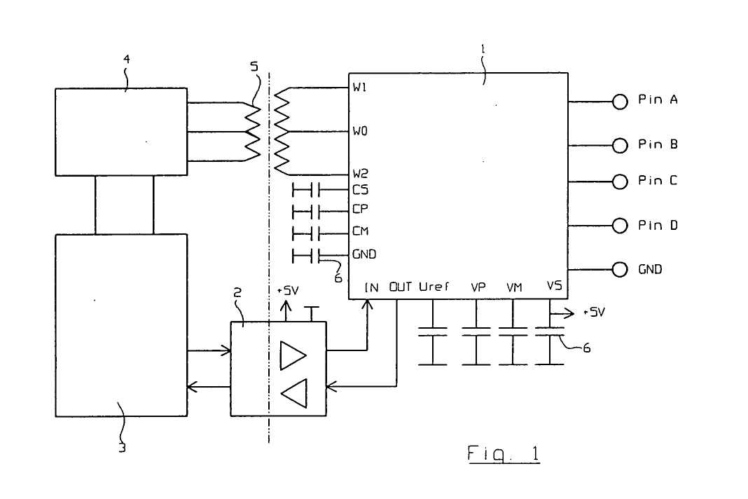

In the following, the invention is explained in more detail with reference to an embodiment in connection with the drawing. Initially, reference shall be made to FIG. 1.

The essential element of the interface circuit is an interface circuit chip 1, which has several I/O pins, which here are designated by pin A to pin D, and also a ground connection, which is designated by GND. These are the connections which realize the process connections; thus, e.g., data, measurement values, control commands, and the like are exchanged with external instruments or machines. The interface circuit chip 1, which is called simply chip 1 in the following, has two further connections IN, OUT for communicating with a logic circuit 3, which is formed, e.g., as an FPGA or ASIC. Here, the communication is realized over a decoupling device 2, which can be, e.g., an optocoupler, a magnetocoupler, a transformer, or some other known device for decoupling. The communication is realized bidirectionally, thus from chip 1 to logic circuit 3 via the connection OUT or vice versa from the logic circuit 3 to chip 1 via the connection IN.

For a decoupled power supply, a DC/DC driver 4 is provided, which is connected via a transformer 5 to connections W0, W1, and W2 of the chip 1. Finally, the chip 1 has even more connections (C5, CP, CM, Uref, VP, VM, V5, GND) for external circuitry, which are realized, e.g., by capacitors 6.

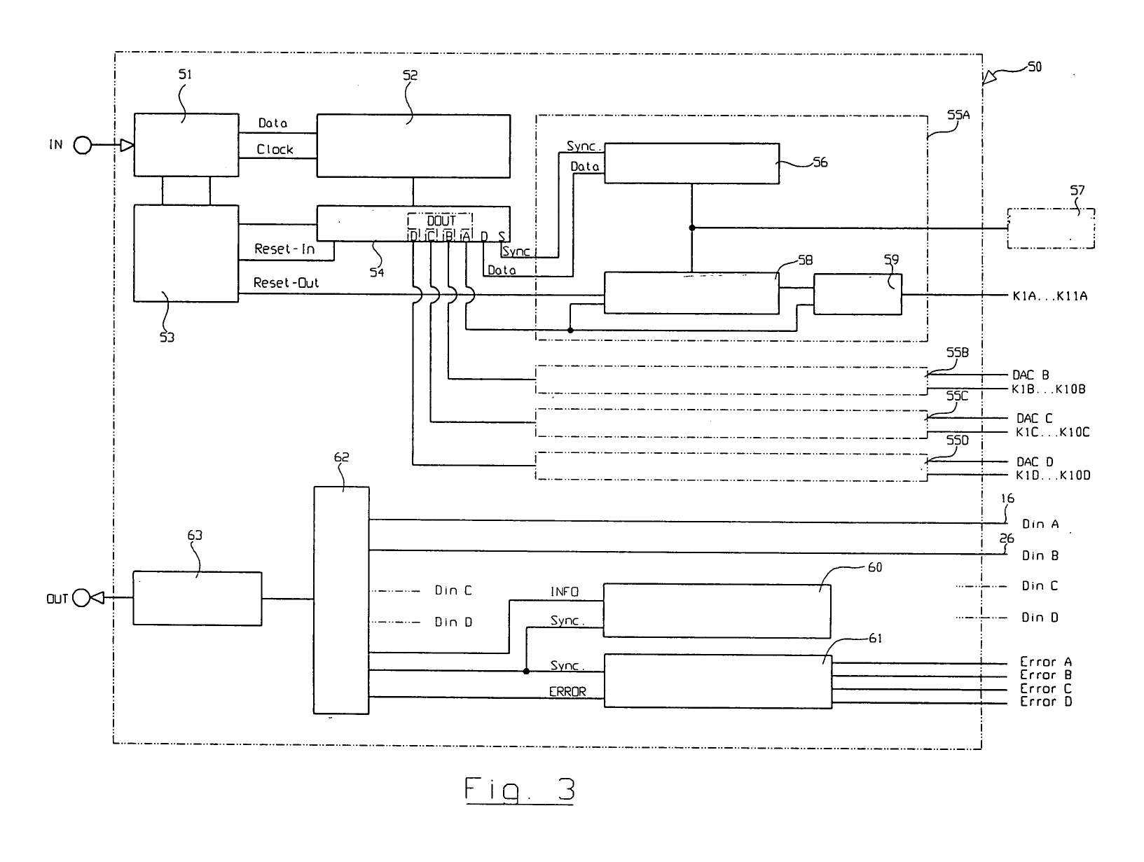

In connection with the FIGS. 2 and 3, an interface circuit architecture with four I/O pins, namely pin A, pin B, pin C, and pin D is described. Because the circuit is always identical for a pair of pins, only the circuit for the pair of pins A and B is shown. The circuit for the pair of pins C and D is then configured identically.

Pin A is connected via a line to a first multiplexer 11 (MUX 1A) and a second multiplexer 12 (MUX 2A). The output of the multiplexer 11 is connected to comparison inputs of two comparators 13 and 14 (KOMP 1A and KOMP 2A), which are used for the function of analog/digital conversion. The outputs of both comparators 13 and 14 are connected to a hysteresis circuit 15, whose output 16 (Din A) is connected to a logic circuit 50 (FIG. 3).

Pin A is further connected to a connection of a controllable changeover switch 17 (S1 A), whose other connections are connected to the multiplexer 11 and to a capacitor 18 (C1 A). The switch can be changed by a control input (K1 A). The changeover switch 17 with capacitor 18 is used as a sample-and-hold circuit for analog/digital conversion, to be described further below.

Pin A is further connected via a line to a multiplexer 21 (MUX1 B), at whose output two comparators 23 (KOMP1 B) and 24 (KOMP2 B) are connected. In a corresponding way, the outputs of the comparators 23 and 24 are connected to a hysteresis circuit 25, which is connected in turn via its output 26 (Din B) to the logic circuit 50.

There are also two registers 18 and 28 (DAC A register and DAC B register) for digital/analog conversion, to which digital/analog converters 19 (DAC A) and 29 (DAC B) are connected, respectively. The output of the digital/analog converter 19 is connected to the reference inputs of the comparators 13 (KOMP1 A) and 24 (KOMP2 B). The output of the digital/analog converter 29 (DAC B) is connected to the reference inputs of the comparators 23 (KOMP1 B) and 14 (KOMP2 A) and also to a third input of the multiplexer 11.

The output of the digital/analog converter 19 is connected to a connection of the multiplexer 12 and also to a connection of a multiplexer 22 (MUX2 B), which is connected to pin B. The output of the digital/analog converter 29 (DAC B) is also connected to connections of the multiplexer 12 and 22. A voltage/current converter 31 is allocated to the multiplexer 12 and a voltage/current converter 32 is allocated to the multiplexer 22, which are connected to the digital/analog converter 19 and to the digital/analog converter 29, respectively, and which each have a measurement resistor 33 (R1 A) and 34 (R1 B), respectively, which are connected to the associated multiplexer 12 and 22, respectively. Finally, the multiplexers 12 and 22 each have a ground connection 35 and 36, respectively, whose function is explained further below.

Between pin A and B, there is a series circuit made up of a resistor 37 (R2) and a controllable switch 38 (S2), which can be controlled by means of a control connection (K8).

Pin B is further connected to a changeover switch 39 (S4), whose output is connected to the multiplexer 21 and to another sample-and-hold circuit consisting of a changeover switch 40 (S1 B) and a capacitor 41 (C1B), wherein the changeover switch can be changed by means of a control input K1 B. The other connection of the changeover switch 40 is connected to the multiplexer 21.

For the second connection of the changeover switch 39, which can be controlled by means of a control input K11, two variants are possible. In the first variant, this connection is connected via a line 42 to the common node of the resistor 37 and the switch 38. In the second alternative, instead of the line 42, a series circuit consisting of a changeover switch 43, a differential amplifier 44, and a gain regulator 45, which is connected as follows: a connection of the changeover switch 43 (S3) is connected to the common node between the resistor 37 and the switch 38. The other input connection is connected to pin B. The output of the switch 43 is connected to an input of the differential amplifier 44, whose other connection is connected to pin A. The output of the differential amplifier 44 is connected to the input of the gain regulator 45, whose output is then connected to the other connection of the changeover switch 39 (S4). The gain regulator can be controlled via a control connection K10.

The multiplexers 11, 21, 12, and 22 can each be controlled by means of control inputs K4 A, K3 A, or K4 B, K3 B, or K7 A, K6 A, K5 A, or K7 B, K6 B, K5 B.

The circuit for pins C and D is configured identically, as indicated by the block 46.

Chip 1 also has the aforementioned ground connection GND.

The connections 16 (D IN A), 26 (D IN B), 47 (D OUT A), and 48 (D OUT B) merely represent connections of the logic circuit 50, which illustrates the connection between FIGS. 2 and 3. The DAC registers 18 and 28 and also all of the aforementioned control connections K are connected to a control circuit 50, which is illustrated in more detail in FIG. 3 and which produces the bidirectional connection to the logic circuit 3 of FIG. 1 via the connections IN and OUT, respectively.

For the interface circuit architecture shown in FIG. 2 as an example, the decoupling is realized far ahead of the I/O pin; i.e., of the analog functions, only the digital/analog converter and the comparators 13, 14, 23, 24 are integrated on the interface circuit side.

The analog/digital conversion (ADC) is performed according to the principle of successive approximation in connection with the logic circuit 3 (FPGA).

At the beginning of the measurement, the input voltage at pin A and pin B is buffered in the sample/hold stage 17, 18 or 40, 41. This is compared with the output of the digital-analog converter 19 or 29, which is initially set to half the full end-scale deflection (at 12 bit 2048=800 h). The result (output of the comparator 13, 14 or 23, 24) is transferred as one bit in the serial data stream to the logic circuit 3 (FPGA). Thus, only one bit of the result is detected, and then the value of the digital-analog converter 19 or 29 (DAC A or DAC B) is reset. For this purpose, a completely new digital-analog converter value need not be transferred to chip 1, instead only the digital-analog converter register 19 or 28 is changed as a function of the previous comparator result (the current bit is set equal to the result, the next lowest bit is set=1). This is repeated sufficiently to complete the conversion.

In the following, the operating modes of the circuit of FIG. 2 is described in connection with the following Tables 1, 2a, and 2b.

Overvoltage protection at the I/O pins was left out for reasons of clarity, since this has no influence on the principle method of operation.

The following description relates to the operating modes, which use only one I/O pin (so-called 1-pin operating modes), on I/O pin A. The description is then valid also for I/O pin B, I/O pin C, and I/O pin D. For the 2-pin operating modes, two I/O pins are used; the description then relates to I/O pin A and I/O pin B. The description then applies analogously also for I/O pin C and I/O pin D. All operating modes are set by signals to the control inputs K1-K11, which can be taken from the following Tables 1, 2a, and 2b.

1-pin operating modes (see FIG. 2 and Table 1)

TABLE 1
Summary of the configuration K1-K11
for 1-pin operating modes

| | K1 | K2 | K4 | | K7 | | | K8 | K9 | K10 | | |
|---|---|---|---|---|---|---|---|---|---|---|---|---|
| Mode | 0=hold | 1=on | Mux 1 | K3 | Mux 2 | KB | K5 | 1=on | 1=U | 0=P | K11 | Dout |
| Digital In | 0 | nB | 0 | 0 | 0 | 0 | 0 | 0 | 0 | 0 | 0 | x |
| Digital Out: | 0 | 0 | 0 | 0 | /D | 0 | 0 | 0 | 0 | 0 | 0 | =/K7 |
| OD | | | | | | | | | | | | |
| Digital Out: | 0 | 0 | 0 | 0 | 1 | 0 | D | 0 | 0 | 0 | 0 | =KS |
| PP | | | | | | | | | | | | |
| Digital Out: | 0 | 0 | 0 | 0 | 1 | /D | 1 | 0 | 0 | 0 | 0 | =/KB |
| LH | | | | | | | | | | | | |
| Analog In: U | SH | 0 | 0 | 1 | 0 | 0 | 0 | 0 | 0 | 0 | 0 | x |
| ground- | | | | | | | | | | | | |
| referenced | | | | | | | | | | | | |
| Analog Out: | 0 | 0 | 0 | 0 | 1 | 0 | 1 | 0 | 0 | 0 | 0 | x |
| U A B | 0 | 0 | 0 | 0 | 1 | 0 | 1 | — | — | — | — | x |
| Analog Out: I | 0 | 0 | 0 | 0 | 1 | 1 | 0 | 0 | 0 | 0 | 0 | x |
| PIN as GND | 0 | 0 | 0 | 0 | 1 | 0 | 0 | 0 | 0 | 0 | 0 | x |
| Test see | | | | | | | | | | | | |
| below | | | | | | | | | | | | |
| Read-Back | | | | | | | | | | | | |
| see below | | | | | | | | | | | | |

Explanation of abbreviations: nB=if necessary (initialization), OD=open drain, PP=null high, LH=low high, D=Dout, /D=D inverted, SH=sample/hold (0=hold), U=voltage, I=current, −=not applicable or not present, x=don't care

Note on Test and Read-Back:

Both modes are listed only for completeness; also, the circuitry for these modes was left out in FIG. 3 for reasons of clarity. This has no effect on the principle method of operation.

Digital-In (Type Ground-Referenced):

This operating mode uses only one I/O pin, but two digital-analog converters 19 and 29 for setting thresholds and hysteresis behavior, so that every two I/O pins A and B or C and D have the same properties. The digital-analog converter 19 (DAC A) supplies the threshold, the digital-analog converter 29 (DAC B) is set by the hysteresis behavior below the digital-analog converter 19 (DAC A). By means of the multiplexer 11 (Mux 1A) (with K4A, K3A=00 b), the input voltage of I/O pin A is applied to the + input of comparator 13 (Komp 1A), which compares this voltage with that of digital-analog converter 19 (DAC A). Correspondingly, comparator 12 (Komp 2A) compares it with that of digital-analog converter 29 (DAC B). The evaluation relative to hysteresis circuit 15 is performed digitally, with the hysteresis circuit 15 being able to be switched on and off with K2A.

This applies correspondingly to I/O pin B, only that here the function of comparator 23 (Komp 1B) and comparator 24 (Komp 2B) are exchanged.

Digital Out (Type PP, Low<0.4 V, High=Digital-Analog Converter 19 (DAC A):

This operating mode uses only one I/O pin. The low level is =GND, the high level is given by the digital/analog converter 19 (DAC A), which is used for I/O pins A and B, so that every two I/O pins have the same properties. The multiplexer 12 (Mux 2A) switches between these two states. If Dout A=0, GND (=low level) is applied via the multiplexer 12 (Mux 2A) (with K7A, K6A, K5A=100 b) to I/O pin A. If Dout A=1, then the output voltage of digital-analog converter 19 (DAC A) is applied as high level to I/O pin A (with K7A, K6A, K5A=101 b). The changeover is performed for avoiding spike pulses at the output by changing only one bit at multiplexer 12 (Mux 2A) (=K5A). A corresponding condition applies to I/O pin B.

The digital-analog converter 29 (DAC B) and other circuit parts are open and can be used, e.g., for measuring the current voltage on both I/O pins.

Digital Out (Type LH, Low=DAC B, High=DAC A):

This operating mode uses only one I/O pin. The low level is given by digital-analog converter 29 (DAC B), the high level by digital-analog converter 19 (DAC A). Both are used for I/O pins A and B, so that every two I/O pins have the same properties. The multiplexer 12 (Mux 2A) switches between these two states. If Dout A=0, the output voltage of digital-analog converter 29 (DAC B) is applied as low level to I/O pin A (K7A, K6A, K5A=111 b). If Dout A=1, the output voltage of digital-analog converter 19 (DAC A) is applied as high level to I/O pin A (K7A, K6A, K5A=101 b). The changeover is performed for avoiding spike pulses at the output by changing only one bit at multiplexer 12 (Mux 2A) (=inverted K6A). A corresponding situation applies to I/O pin B.

Digital Out (Type OD, Low=GND, High=Open Drain):

This operating mode uses only one I/O pin. The low level is =GND, the high level is open drain. The multiplexer 12 (Mux 2A) switches between these two states. If Dout A=0, then GND (=low level) is applied via multiplexer 12 (Mux 2A) (K7A, K6A, K5A=100 b) to I/O pin A. If Dout A=1, then I/O pin A is n.c. (=not connected) (K7A, K6A, K5A=000 b). The changeover is performed for avoiding spike pulses at the output by changing only one bit at multiplexer 12 (Mux 2A) (=inverted K7A). A corresponding situation applies to I/O pin B.

The digital-analog converter 19 (DAC A), the digital-analog converter 29 (DAC B), and other circuit parts are open and can be used, e.g., for measuring the present voltage at the two I/O pins.

Analog In (Type Voltage, Ground Referenced):

This operating mode uses only one I/O pin. At the beginning of the conversion, the input voltage at I/O pin A is stored on the capacitor 18 (C1A) over the switch 17 (S1A) for the entire duration of the conversion. The comparator 1A compares this voltage with that of digital-analog converter 19 (DAC A) and performs the A/D conversion, as described above. Then, by changing the switch 17 (S1A) back, the current value at I/O pin A is stored in capacitor 18 (C1A). A corresponding situation applies for I/O pin B.

To reduce the power consumption, all operating modes, which include A/D conversion, can be switched between continuous or triggered.

Analog Out (Type Voltage):

This operating mode uses only one I/O pin. The output voltage of digital-analog converter 19 (DAC A) is applied via the multiplexer 12 (Mux 2A) to the I/O pin A (K7A, K6A, K5A=101 b).

A corresponding situation applies for I/O pin B, although with K7B, K6B, K5B=111 b.

Analog Out (Type Current):

This operating mode uses only one I/O pin. The output voltage of digital-analog converter 19 (DAC A) is converted in the current/voltage converter 31 (U/I A) into a constant current and supplied via the multiplexer 12 (Mux 2A) to I/O pin A (K7A, K6A, K5A=110 b). A corresponding situation applies with the current/voltage converter 32 (U/I B) for I/O pin B.

TABLE 2a
Configuration K1-K11 for 2-pin operating modes with true difference gain.

| | K1 | K2 | K4 | | K7 | | | K8 | K9 | K10 | | |
|---|---|---|---|---|---|---|---|---|---|---|---|---|
| Mode | 0=Hold | 1=on | Mux 1 | K3 | Mux2 | K6 | K5 | 1=on | 1=U | 0=P | K11 | Dout |
| Analog In: | 0 | 0 | 0 | 0 | 0 | 0 | 0 | 0 | 1 | nB | 1 | x |
| U A B | SH | 0 | 0 | 1 | 0 | 0 | 0 | — | — | — | — | x |
| Analog In: | 0 | 0 | 0 | 0 | 0 | 0 | 0 | 1 | 0 | — | 1 | x |
| I A B | SH | 0 | 0 | 1 | 0 | 0 | 0 | — | — | — | — | x |

Explanation for abbreviations: nB=if necessary (initialization), SH=sample/hold (0=hold), U=voltage, I=current, −=not applicable or not present, x=don't care

Here, the circuit parts 43, 44, and 45 shown with dashed lines and shading in FIG. 2 are also necessary. The dashed-line connection 42 is eliminated.

Analog In (Type Voltage, Difference):

For this operating mode, two I/O pins are used. The differential amplifier 44 forms the difference between the voltage on I/O pin A (lies directly on the +input of differential amplifier 44) and that on I/O pin B (with K9=1, I/O pin B lies over the switch 38 (S3) on the − input of the differential amplifier 44), if necessary, amplified by the amplifier 45, and then applied via the switch 39 (S4) (K11=1) to the sample-and-hold circuit 40, 41 (S1B) and then converted with the multiplexer 21 (Mux1B) and the comparator 23 (Komp 1B) with the digital-analog converter 29 (DAC B).

Analog In (Type Current, Difference):

This operating mode uses two I/O pins. With K8=1, via the switch 38 (S2), the resistor 37 (R2) for current measurement is connected between I/O pin A and I/O pin B. With the differential amplifier 44, the voltage difference between both connections of the resistor 37 (R2) is formed. The upper connection (=I/O pin A) lies directly on the + input of differential amplifier 44. The lower connection lies with K9=0 over the switch 43 (S3) on the − input of the differential amplifier 44. The difference is amplified, if necessary, by the amplifier 45 and then applied via the switch 39 (S4) (K11=1) to the sample-and-hold circuit 40, 41 (S1B) and then converted with the multiplexer 21 (Mux 1B) and the comparator 23 (Komp 1B) with the digital-analog converter 29 (DAC B).

If the signal at input 0 of multiplexer 1B has also been applied to another input 3 of multiplexer 1A, digital-analog converters 19 (DAC A) could be used together with comparator 14 (Komp 2A) to realize an overvoltage protection circuit. With the digital-analog converter 19 (DAC A), a threshold could then be set and if it is exceeded, the switch 38 (S2) is automatically switched off to protect the resistor 37 (R2) from an overload. This circuit would react very quickly within the chip 1 without secondary effect on the FPGA side. An error would be reported to the FPGA.

TABLE 2b
Configuration K1-K11 for the 2-pin operating modes with pseudo difference again

| | K1 | | K4 | | K7 | | | K8 | | | | |
|---|---|---|---|---|---|---|---|---|---|---|---|---|
| Mode | 0=Hold | K2 1=on | Mux 1 | K3 | Mux 2 | K8 | K5 | 1=on | K8 1=U | K100=P | K11 | Dout |
| Analog In: U | SH | 0 | 0 | 1 | 0 | 0 | 0 | 0 | 0 | 0 | 0 | x |
| A B | SH | 0 | 0 | 1 | 0 | 0 | 0 | — | — | — | — | x |
| Analog In: A | SH | 0 | 0 | 1 | 0 | 0 | 0 | 1 | — | 0 | 0 | x |
| B | SH | 0 | 0 | 1 | 0 | 0 | 0 | — | — | — | — | x |

Explanation of abbreviations: nB=if necessary (initialization), SH=sample/hold (0=hold), U=voltage, I=current, −=not applicable or not present, x=don't care

Here, the circuit parts 43, 44, and 45 shown with dashed lines and shading in FIG. 2 can be eliminated and replaced by the dashed-line connection 42.

Analog In (Type Voltage, Difference):

For this operating mode, two I/O pins are used. The voltages on I/O pin A and I/O pin B are sampled and converted independently of each other simultaneously in the capacitors 18 and 41 (C1A and C1B, respectively), as described for the operating mode analog in (type voltage, ground-referenced). The difference is formed first on the digital side in the FPGA.

Analog In (Type Current, Difference):

This operating type uses two I/O pins. With K8=1, via the switch 38 (S2), the resistor 37 (R2) for current measurement is connected between I/O pin A and I/O pin B. The voltages on both connections of R2 are measured independently of each other. The voltage at the upper connection of the resistor 37 (R2) corresponds to the voltage on I/O pin A, which lies on the lower connection over the dashed-line connection and the switch 39 (S4) (K11=1) to the sample-and-hold circuit 40, 41 (S1B). Both voltages are sampled and converted simultaneously in the capacitors 18 and 41 (C1A and C1B), as described for the operating mode analog in (type voltage, ground-referenced). The difference is formed first on the digital side in FPGA 3.

FIG. 3 shows a block circuit diagram of the logic circuit 50 with the connections IN and OUT, via which the communications are performed with the logic circuit 3 (FIG. 1) by means of the decoupling device 2. In general, in each direction there is a data stream. In the direction of the logic circuit 3 to the chip 1, the data is transmitted initially for the programming of the chip 1. This data transmits the control inputs K1 A to K10 D, K11 A, K1 B to K10 B, K1 C to K11 C, K1 D to K10 D for programming the switch, the multiplexer, and the other components of FIG. 2.

First, the circuit shall be described. From the connection IN a line leads to a logic circuit 51, which separates clock signals and data, and from there sends them separately to an input shift register 52 and a reset and control logic 53. The input shift register 52 and the reset and control logic 53 are connected to a control latch 54, whose outputs (A, B, C, D) correspond to the blocks 47 (DOUT A) and 48 (DOUT B) and corresponding connections for the pins C and D of FIG. 2. Further outputs “data” and “sync” are connected to a “hyper-serial” shift register 56 (the term “hyper-serial” is explained further below). In turn, this is connected to the DAC register 18, which is here shown again for better understanding, and also to a register 58 for operating modes and configuration. The output of the register 58 is connected to a logic circuit 59, whose outputs are connected to the configuration connections K1 A to K11 A. The aforementioned components 56, 18, 58, and 59 are assembled as block 55A for the pin A. In an analogous way, identical components 55 B, 55 C, and 55 D are provided for the pins B, C, and D.

In the direction from chip 1 toward logic circuit 3 (FIG. 1), the connections 16, 26 for Din A, Din B, and also, in an analogous way, for Din C and Din D are provided, which are connected to a status latch 62 and to the connection OUT via an output shift register 63. In addition, logic circuits 60 and 61 are provided, which represent data channels for information or for error reports, and are likewise connected to the status latch 62. By the “hyper-serial” transmission, the logic circuit 60 delivers information on the chip itself, its current configuration, etc. This information is referenced either from permanently programmed memory cells in the chip, such as a manufacturer identification, or by fetching the set configuration of the chip, e.g., the current state of the switches K1 A-K11 A, K2 B-K10 B, etc.

In principle, the logic circuit 61 works in the same way for error information, which can appear in the configuration or during operation. The logic circuit 61 obtains this information via lines “Error A” to “Error D,” with each of these lines being able to represent a plurality of such individual information. For example, excess current and/or overvoltage detection could be installed for each of the pins.

In the following, the principle of operation of the circuit of FIG. 3 is explained in more detail.

The Data Stream from/to Interface Circuit Chip:

A serial 1-bit data stream is provided in each direction. In the simplest case, this can be an asynchronous data stream, but a synchronous data stream is advantageous, because here a continuous clock can be reconstructed also on the interface circuit side without a separate quartz oscillator. The data stream to chip 1 runs continuously with fixed definition of the bits. On the interface circuit side, the clock is filtered out from this data stream (51) and used for various purposes in chip 1, e.g., also for sending data from chip 1 to FPGA 3. The transmission of data from chip 1 likewise happens with a fixed definition of the bits. In total, for each direction 8 bits is sufficient, which repeats according to the data stream.

To increase the possible uses of chip 1, the type of communications (sync., async., SPI) can also be configured in chip 1.

Transmission Reliability, Parity:

In each direction, a parity bit is formed over a transmitted 7-bit word and sent as the last data bit. This is tested on both sides. For a transmission error from FPGA 3 to chip 1, this can detect the error and then transmit an error bit back in the next transmitted word. The type of error can be coded and transmitted with the word, as described below.

“Hyper-Serial” Transmission:

First, the term “hyper-serial” will be explained. Between the chip 1 and the FPGA 3, a continuous data stream runs in both directions in sync with the clock, which is generated in FPGA 3 and is contained in the data stream. The actual information is transmitted in series in both directions, e.g., with 8-bit words. After the transmission of such an 8-bit word, the transmission of the next 8-bit word begins immediately. The meaning of the individual bits can be selected freely and is explained further below in an embodiment. Thus, there for each of the four pins A, B, C, and D, e.g., one bit is provided, which fixes the state of the output if the pin was configured as an output. Thus, with each transmitted 8-bit word, one can change the state of one or more pins. To change the state of an output pin, one must wait until an 8-bit word has been transmitted again. Only then is the change effective on the output pin. This limits the maximum rate of change. For a 100 MHz transmission rate between the blocks 1 and 3 in FIG. 1, one thus achieves a maximum rate of change of 1 per 80 ns, although also for all four pins simultaneously. If another operating mode is configured for one pin (different than an output pin), one can define the corresponding bit in the 8-bit word differently. In the next section, “The data stream to the interface circuit chip,” the meaning of bits 4 and 6 is also illustrated. These are used for the so-called hyper-serial transmission. Here, in each 8-bit word, only one bit of certain information is transmitted. Therefore, it lasts considerably longer, up until the information has been completely transmitted. The beginning of the new transmission is shown by bit 4 in the 8-bit word. If this bit is equal to 0, the first bit of the information is delivered in bit 6 (=data). In the next 8-bit word, then the next bit of information follows, etc. The transmission of the complete information is therefore slow. The type of information and its length are likewise transmitted with the word, so that different information can also require a different length of time. The same principle is also used for the hyper-serial transmission from block 1 to block 3. Here, e.g., a code can be retrieved, which allows the manufacturer of the chip to be identified.

In addition, for both communications directions, for each I/O pin and for general information and error reports, so-called hyper-serial data channels are provided (cf., e.g., from chip 1 to FPGA 3 the blocks 60 and 61 in FIG. 3). They form a word-serial transmission for information, which is longer than one bit, i.e., in each 8-bit word only one bit for the information to be transmitted is supplied. At the beginning of a word-serial transmission, e.g., for the transmission of new digital-analog converter values to chip 1, the so-called SYNC bit in the 8-bit word is set. In this way, the chip 1 recognizes that the first bit of a hyper-serial transmitted message, in this case, the new digital-analog converter values, is transmitted. With each 8-bit word one bit for each of the four digital-analog converter values is then transmitted. The number of bits of a message is either fixed, can be transmitted with the message at the beginning of each message, or is determined by the period of SYNC. Because the transmission rate for magnetocouplers can currently reach up to 100 Mbps, a transmission rate of about 10 Mbps per I/O pin can be achieved.

The Data Stream to the Interface Circuit Chip:

| Bit | Name | Meaning |
|---|---|---|
| 0 | PINA | Data for I/O pin A, meaning according to each |
| | | operating mode of the pin |
| 1 | PINB | Data for I/O pin B, meaning according to each |
| | | operating mode of the pin |
| 2 | PINC | Data for I/O pin C, meaning according to each |
| | | operating mode of the pin |
| 3 | PIND | Data for I/O pin D, meaning according to each |
| | | operating mode of the pin |
| 4 | SYNC | 1 = beginning of hyper-serial data |
| | | transmission |
| 5 | RES | Reset: 0 = all I/O pins high-resistance |
| | | inputs |
| | | 1 = all I/O pins set as for initialization |
| 6 | DATA | Hyper-serial data channel for diverse |
| | | information |
| 7 | PARITY | Parity over bit 0-6 |

The Hyper-Serial Command Set for the Interface Circuit Chip:

After power-on, all bits for all I/O pins are set=0, the I/O pins are then high-resistance inputs. The configuration of the I/O pins happens in a hyper-serial method as follows:

The first of the 8-bit words transmitted for initialization determines the operating mode of the serial data transmission after power-on-reset (or after the RES bit has returned to 1). Then the initialization of the operating modes follows for the 4 pins, with the bits 3-0 of each word containing in the hyper-serial method the operating mode for the I/O pins 3-0, beginning with the highest-value bit of the initialization in the first transmitted 8-bit word. At the beginning of the initialization values, the SYNC bit is also set. Then, the hyper-serial transmission of the initialization values for the 4 analog/digital converters follows.

However, these settings are only active when bit 5 is set=1 (=RES). If bit 5 is set=0 in a later word, all I/O pins are reset into mode 0 and the initialization of the mode must be repeated.

The Data Stream of the Interface Circuit Chip:

| Bit | Name | Meaning |
|---|---|---|
| 0 | COMP0 | Output of comparator 13, 14 or hysteresis |
| | | logic 15 from I/O pin A |
| 1 | COMP1 | Output of comparator 23, 24 or hysteresis |
| | | logic 25 from I/O pin B |
| 2 | COMP2 | Output of comparator or hysteresis logic from |
| | | I/O pin C |
| 3 | COMP3 | Output of comparator or hysteresis logic from |
| | | I/O pin D |
| 4 | SYNC | 1 = Beginning of INFO or an error report |
| 5 | ERROR | Hyper-serial data channel for error report |
| 6 | INFO | Hyper-serial data channel for info |
| 7 | PARITY | Parity over bit 0-6 |

Bits 5 and 6 each deliver a hyper-serial data stream. Bit 5 supplies an error report or 0, bit 6 consists of diverse information, e.g., chip version and revision, manufacturer, configured mode, etc. The beginning of the transmission is introduced with SYNC=1, then follow the data, beginning with the highest-value bit in the predetermined format, depending on the corresponding chip 1.

If an error is detected in chip 1, the corresponding bit is set in the error information transmitted in a hyper-serial method in bit 5. The error report is repeated until an error is no longer detected.

Structure of the Hyper-Serial Error Report (Example):

| Bit | Meaning |
|---|---|
| 0 | Parity error appeared in reception |
| 1 | High temperature in chip 1 |
| 2 | Transient decrease in power supply voltage (brown |
| | out) , see bit 3-5 |
| 3 | Power supply voltage P3 or P5 defective |
| 4 | Power supply voltage P12 or P15 defective |
| 5 | Power supply voltage M12 or M15 defective |
| 6 | Pin A: Excess current at output or overvoltage at |
| | input |
| 7 | Pin B: Excess current at output or overvoltage at |
| | input |
| 8 | Pin C: Excess current at output or overvoltage at |
| | input |
| 9 | Pin D: Excess current at output or overvoltage at |
| | input |
| 10 | Chip 1 defect |
| 11 | Reserved |
| 12 | Reserved |

Start Condition, Power On:

In power-off mode, the DC/DC converter 4 is switched off; thus, the chip 1 contains no supply of power. The communications pin OUT from chip 1 to FPGA 3 indicates this with low level. After turning on the DC/DC converter 4, and thus the power supply for the chip 1, the chip 1 detects the power-good situation (=all power supply voltages in the desired range), performs a power-on-reset, and indicates to the FPGA 3 its readiness for communications by a high level at the communications pin OUT. The first activities via the communications pins IN and OUT are used to exchange timing information and to initialize the serial interface (type of communication, baud rate, etc.). Until this time, the I/O pins remain high-resistance inputs.

Now the FPGA 3 can begin with the communications and sends diverse initialization data. The I/O pins are configured immediately and set to the initialization values for outputs.

Here, another advantage of this arrangement can be seen, because a separate, local initialization with separate EEPROM is not required for each chip 1; instead, this can be performed for all chips 1 from FPGA 4 with an EEPROM for all initialization values.

If the data transmission stops, the chip 1 returns to the reset mode after a certain time, likewise if the DC/DC converter 4 fails or one of the power supply voltages fails.

| | DC/DC- | Data transmission | |
|---|---|---|---|
| State, Phase | Converter | (synchron IN, OUT) | I/O-Pins |
| Power-Off | inactive | None, IN = 0, OUT = 0 | High resistance |
| Power-No-Good | active | None, IN = 0, OUT = 0 | High resistance |
| Power-Good | active | None, IN = 0, OUT = 0 | High resistance |
| Power-On-Delay | active | None, IN = 0, OUT = 1 | High resistance |
| CLK-tnit | active | Timing-evaluation | High resistance |
| COM-Init | active | Init type and baud rate | High resistance |
| I/O-init | active | bidirectional | active |
| Aktiv | active | bidirectional | active |
| Power-Down | active | None, IN = 0, OUT = 0 | active |
| Passive | active | None, FPGA stops | High resistance |
| | | OUT-Pin = High | |
| Defect | inactive | OUT-Pin = Low | High resistance |

In the phase I/O Init, the first four transmitted 8-bit words set the operating mode of the four I/O pins and the Init state of the digital outputs. Then, with SYNC=1, the beginning of the hyper-serial transmitted DA values follows. With the next 8-bit word, by RES=1 the previously set values for the modes, analog/digital converter, and digital outputs are activated, with the chip 1 being active. The RES bit always remains set until a reset is necessary.

Example for I/O Initialization:

According to the mode, either for each byte only one bit is transmitted or with SYNC=1 the next analog/digital converter value or values is transmitted.

| Bit-No | | | | | | | | |
|---|---|---|---|---|---|---|---|---|
| 7 | 6 | 5 | 4 | 3 | 2 | 1 | 0 | |
| PAR | INFO | RES | SYNC | PIN D | PIN C | PIN B | PIN A | Function |
| P | 0 | 0 | 1 | MODD3 | MODC3 | MODB3 | MODA3 | Init Mode Bit 3 |
| P | 0 | 0 | 0 | MODD2 | MODC2 | MODB2 | MODA2 | Init Mode Bit 2 |
| P | 0 | 0 | 0 | MODD1 | MODC1 | MODB1 | MODA1 | Init Mode Bit 1 |
| P | 0 | 0 | 0 | MODD0 | MODC0 | MODB0 | MODA0 | Init Mode Bit 0 |
| P | 0 | 0 | 0 | PIND | PINC | PINB | PINA | Init Digital |
| | | | | | | | | Outputs |
| P | 0 | 0 | 1 | DAD11 | DAC11 | DA111 | DA011 | Init DACs Bit 11 |
| P | 0 | 0 | 0 | DAD10 | DA210 | DA110 | DA010 | Init DACs Bit 10 |
| P | 0 | 0 | 0 | DAD9 | DA29 | DA19 | DA09 | Init DACs Bit 9 |
| P | 0 | 0 | 0 | DAD8 | DA28 | DA18 | DA08 | Init DACs Bit 8 |
| P | 0 | 0 | 0 | DAD7 | DA27 | DA17 | DA07 | Init DACs Bit 7 |
| P | 0 | 0 | 0 | DAD6 | DA26 | DA18 | DA08 | Init DACs Bit 6 |
| P | 0 | 0 | 0 | DAD5 | DA25 | DA15 | DA05 | Init DACs Bit 5 |
| P | 0 | 0 | 0 | DAD4 | DA24 | DA14 | DA04 | Init DACs Bit 4 |
| P | 0 | 0 | 0 | DAD3 | DA23 | DA13 | DA03 | Init DACs Bit 3 |
| P | 0 | 0 | 0 | DAD2 | DA22 | DA12 | DA02 | Init DACs Bit 2 |
| P | 0 | 0 | 0 | DAD1 | DA21 | DA11 | DA01 | Init DACs Bit 1 |
| P | 0 | 0 | 0 | DAD0 | DA20 | DA10 | DA00 | Init DACs Bit 0 |
| P | 0 | 1 | 1 | DAD11 | DA211 | DA111 | DA011 | DAC-Values Bit 11 |
| P | 0 | 1 | 0 | DAD10 | DA210 | DA110 | DA010 | DAC-Values Bit 10 |

The I/O Pins:

Corresponding to requirements, the pins are resistant to overvoltage and short circuit conditions. According to the manufacturing process of the chip 1, typical process I/O standards are maintained as much as possible without special external circuitry.

The I/O pin CLK1 is usually not necessary, because, as mentioned above, the clock is contained in the transmitted data and can be extracted with known standard methods and standard codings, e.g., the so-called Manchester coding on the receiver side, here, the block.

The I/O pin CLK1 is thus provided for operating modes, which require an external clock, e.g., for asynchronous operating mode, for which the clock cannot be extracted from the data stream. For the preferred synchronous operating mode, it is not required, and is thus used for setting the configuration (to GND, V5, or n.c.).

The I/O pin Uref must be applied to GND via a capacitor. It can also be used to replace the on-board reference voltage by an external reference.

| | | | | |
|---|---|---|---|---|
| W1 | 0 | 1 | 10 | A |
| W0 | 0 | | | B |
| W2 | 0 | | | C |
| SDI | 0 | | | D |
| SDO | 0 | | | GND |
| C5 | 0 | | | V5 |
| CP | 0 | | | VP |
| CM | 0 | | | VM |
| GND | 0 | | | GND |
| CLKI | 0 | 10 | 11 | Uref |

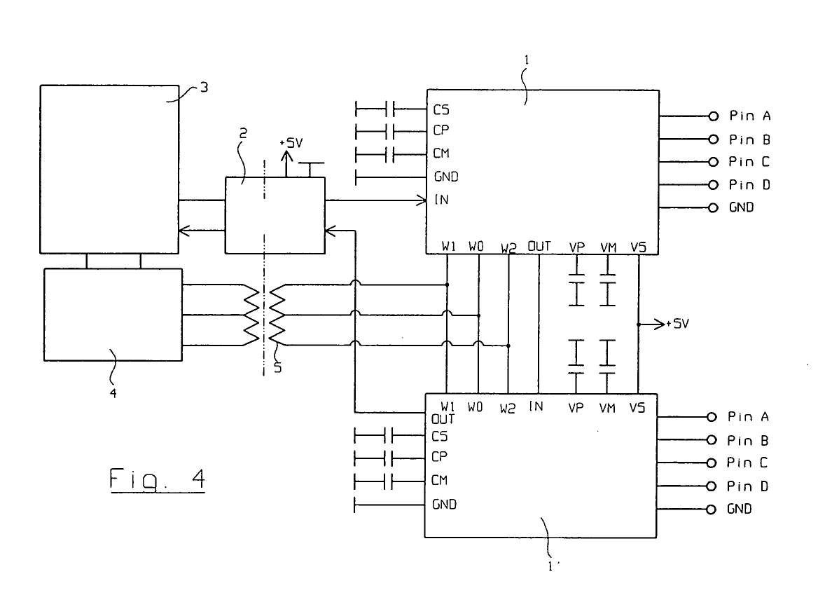

Cascade Arrangement of Interface Circuit Chip (FIG. 4):

Several chips 1, 1′ can be operated via the same decoupling device 2 and the same communications channel. Here, only Data-OUT of the first chip 1 must be connected to Data-IN of the next chip 1′. The identification of the sequence in the chips 1 is made via the first 8-bit word after power-on-reset. If CASC=1, the process is dealing with the primary chip 1. For the secondary chip 1′, CASC is =0. The serial data is transmitted in the sequence of chip 1, thus in the direction of chip 1 initially the 8-bit word for the primary chip 1, then that for the next, etc.

Setting the Operating Mode of the Serial Interface:

To enable other possible uses for the chips 1, the methods of serial data transmission can be adjustable, e.g., synchronous, asynchronous, or SPI.

Thus, there is the possibility of connecting the chip 1 to the typical serial interfaces and to the SPI interface provided for many microcontrollers and DSPs (=digital signal processors). The control can also be performed asynchronously by software.

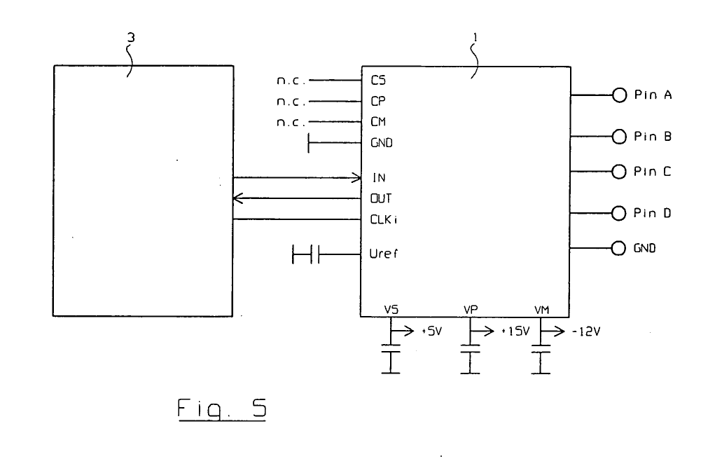

Operation Without Decoupling (FIG. 5):

A chip 1 can also be operated without decoupling (individually or cascaded) to reduce costs. FIG. 5 shows the very simple system structure, wherein the communications interface is here configured asynchronously or as SPI. In particular, modern microcontrollers often already provide such serial interfaces.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above methods and products without departing from the scope of the invention, it is intended that all matter contained in the above description and shown in the accompanying drawings shall be interpreted as illustrative and not in a limiting sense.

What is claimed is:

1. An interface circuit for process connections to computers, the interface circuit comprising:
at least one bidirectional input connection;
at least one bidirectional output connection, which is connected to a logic circuit;
a plurality of switches, which can be controlled by signals, whose inputs are connected directly or indirectly to at least one input connection;
several multiplexers which can be controlled by signals;
at least one analog comparator; and
at least one digital/analog converter;
wherein according to the state of one or more of the signals which control the switches and multiplexers the components are activated, deactivated, or changeable into different operating or switching states, with different analog or digital functions being assignable to the one or more bidirectional input connections.

2. The interface circuit of claim 1 wherein the one or more bidirectional output connections are connected over a decoupling device to the logic circuit.

3. The interface circuit of claim 1 wherein the multiplexers can be operated bidirectionally, i.e., as multiplexers and as demultiplexers.

4. The interface circuit of claim 2 wherein the multiplexers can be operated bidirectionally, i.e., as multiplexers and as demultiplexers.

5. The interface circuit of claim 1 wherein the one or more analog comparators are associated with a sample-and-hold circuit, whose input is connected to at least one input connection.

6. The interface circuit of claim 5 wherein the one or more analog/digital converters operate according to the principle of successive approximation.

7. The interface circuit of claim 1 wherein between the one or more input connections and one or more analog comparators, a current/voltage converter is connected, with the connection being switchable by the multiplexer.

8. The interface circuit of claim 1 wherein one or more of the analog comparators are connected after the controllable hysteresis circuit.

9. The interface circuit of claim 1 wherein a digital/analog converter is connected in the signal direction from the output connection to one or more input connections, with the connection being switchable in a controlled way by the multiplexer.

10. The interface circuit of claim 1 wherein at least two input connections are connected to each other over a measurement resistor and a controllable switch, with both connections of the measurement resistor being connected to a differential amplifier, whose output is connected to one or more analog/digital converters.

11. The interface circuit of claim 1 wherein several interface circuits are connected in a cascade arrangement and connected to the logic circuit.

12. The interface circuit of claim 2 wherein several interface circuits are connected in a cascade arrangement and connected to the logic circuit.

13. The interface circuit of claim 9 wherein several interface circuits are connected in a cascade arrangement and connected to the logic circuit.

14. The interface circuit of claim 1 wherein a decoupling device is connected between the interface circuit and the logic circuit.

15. The interface circuit of claim 1 wherein an optocoupler is connected between the interface circuit and the logic circuit.

16. The interface circuit of claim 1 wherein higher functions are implemented in the logic circuit, while only lower functions are implemented in the interface circuit.

17. The interface circuit of claim 16 wherein the higher functions comprise system functions.

18. The interface circuit of claim 16 wherein the logic circuit and the interface circuit are configured such that bidirectional serial communication takes place between these circuits.

19. The interface circuit of claim 17 wherein the logic circuit and the interface circuit are configured such that bidirectional serial communication takes place between these circuits.
